(19) United States
(12) Patent Application Publication
(10) Pub. No.: US 2025/0235787 A1
(43) Pub. Date: Jul. 24, 2025

(54) VIRTUAL CHARACTER CONTROL

(71) Applicant: Tencent Technology (Shenzhen) Company Limited, Shenzhen (CN)

(72) Inventor: Fenlin Cai, Shenzen (CN)

(21) Appl. No.: 19/178,153

(22) Filed: Apr. 14, 2025

Related U.S. Application Data
(63) Continuation of application No. PCT/CN2024/075708, filed on Feb. 4, 2024.

(30) Foreign Application Priority Data
Apr. 13, 2023 (CN) 2023104445126

(51) Int. Cl. A63F 13/58; A63F 13/57; A63F 13/837

(52) U.S. Cl. CPC A63F 13/58; A63F 13/57; A63F 13/837

(57) ABSTRACT

This application discloses a virtual character control method and apparatus, a storage medium, and an electronic device. The method includes: displaying a target virtual character and a first virtual character in a virtual scene; in response to that the target virtual character is in a target state, adjusting a movement speed of the target virtual character to a target speed corresponding to the target state; and in response to that the target speed falls within a target speed range, enabling the target virtual character to obtain a target virtual skill, the target virtual skill being configured for defending against and/or attacking the first virtual character. According to this application, a technical problem that control of the virtual character is monotonous is resolved.

### CROSS-REFERENCE TO RELATED APPLICATIONS

This application is a continuation application of PCT Application PCT/CN2024/075708, filed Feb. 4, 2024, which claims priority to Chinese Patent Application No. 2023104445126 filed on Apr. 13, 2023, each entitled “VIRTUAL CHARACTER CONTROL METHOD AND APPARATUS, STORAGE MEDIUM, AND ELECTRONIC DEVICE”, and each of which is incorporated herein by reference in its entirety.

### FIELD

Aspects described herein relate to the field of computers, and specifically, to virtual character control.

### BACKGROUND

In the field of games, a player controls a virtual character in a virtual game scene through a terminal (such as a mobile phone or a computer). Currently, when a player controls a virtual character to move in a virtual scene, only a position of the virtual character is changed, while a skill of the virtual character is not affected. In this way, the player usually controls the virtual character to quickly move to a designated position, and then performs an operation such as an attack.

Due to the lack of impact of a movement speed on the skill of the virtual character, the player controls, by default, the virtual character to move to a designated position at a fastest speed, and needs to click/tap a corresponding skill casting operation to use a related skill of the virtual character, and the player does not intentionally control the movement speed of the virtual character to change the skill of the virtual character. Consequently, there is a problem that control of the virtual character is monotonous.

For the foregoing problem, no effective solution has been proposed yet.

### SUMMARY

Aspects described herein provide a virtual character control method and apparatus, a storage medium, and an electronic device, to at least resolve a technical problem that control of the virtual character is monotonous.

According to an aspect described herein, a virtual character control method is provided, including: displaying a target virtual character and a first virtual character in a virtual scene; in response to that the target virtual character is in a target state, adjusting a movement speed of the target virtual character to a target speed corresponding to the target state; and in response to that the target speed falls within a target speed range, enabling the target virtual character to obtain a target virtual skill, the target virtual skill being configured for defending against and/or attacking the first virtual character.

In one aspect, the virtual scene further includes a first subordinate virtual character of the target virtual character, and the method further includes: in response to an operation of summoning the first subordinate virtual character by the target virtual character, attaching the first subordinate virtual character to the target virtual character, and switching the state of the target virtual character to an attached state; and the in response to that the target virtual character is in a target state, adjusting a movement speed of the target virtual character to a target speed corresponding to the target state includes: in response to that the target virtual character is in the attached state, reducing the movement speed of the target virtual character to the target speed corresponding to the attached state.

In one aspect, the virtual scene further includes a second subordinate virtual character of the target virtual character, and the method further includes: in response to an operation of summoning the second subordinate virtual character by the target virtual character, enabling the second subordinate virtual character to move along with the target virtual character; and in response to that the target speed falls within the target speed range, enabling the second subordinate virtual character to obtain a first virtual skill, the first virtual skill being configured for defending against or attacking the first virtual character.

In one aspect, the in response to that the target speed falls within a target speed range, enabling the target virtual character to obtain a target virtual skill includes: in response to that the target speed falls within a preset first speed range, enabling the target virtual character to obtain an attack attribute boost skill and a defense attribute reduction skill, the target speed range including the first speed range, and the target virtual skill including the attack attribute boost skill and the defense attribute reduction skill; or in response to that the target speed falls within a preset second speed range, enabling the target virtual character to obtain an attack attribute reduction skill and a defense attribute boost skill, the target speed range including the second speed range, and the target virtual skill including the attack attribute reduction skill and the defense attribute boost skill.

In one aspect, a speed within the second speed range is less than a speed within the first speed range.

In one aspect, the method further includes: in response to that the target speed falls within the first speed range, displaying an attack attribute boost identifier and a defense attribute reduction identifier, the attack attribute boost identifier being configured for identifying that the target virtual character has obtained the attack attribute boost skill, and the defense attribute reduction identifier being configured for identifying that the target virtual character has obtained the defense attribute reduction skill; or in response to that the target speed falls within the second speed range, displaying an attack attribute reduction identifier and a defense attribute boost identifier, the attack attribute reduction identifier being configured for identifying that the target virtual character has obtained the attack attribute reduction skill, and the defense attribute boost identifier being configured for identifying that the target virtual character has obtained the defense attribute boost skill.

In one aspect, the method further includes: when the target speed is greater than a preset first movement speed threshold of the target virtual character, determining that the target speed falls within the first speed range; or when the target speed is less than a preset second movement speed threshold of the target virtual character, determining that the target speed falls within the second speed range, the second movement speed threshold being less than or equal to the first movement speed threshold.

In one aspect, the method further includes: in response to that the target virtual character is in a state in a first group of motion states, determining that the movement speed of the target virtual character falls within the first speed range, the target speed range including the first speed range, and the first group of motion states including at least one of the following states: sprint acceleration, falling off from a higher spot, and jumping in a sprint; or in response to that the target virtual character is in a state in a second group of motion states, determining that the movement speed of the target virtual character falls within the second speed range, the target speed range including the second speed range, and the second group of motion states including at least one of the following states: rolling over, shoulder firing, iron sight, melee, jumping, and squatting.

In one aspect, the enabling the target virtual character to obtain a target virtual skill includes one of the following: enabling the target virtual character to obtain an attacked recovery skill, the attacked recovery skill being configured for increasing a health point of the target virtual character after the target virtual character is attacked; enabling the target virtual character to obtain a hiding skill, the hiding skill being configured for enabling a virtual character or a non-player virtual character that is in a different camp from the target virtual character not to find the target virtual character, and the virtual character or the non-player virtual character in a different camp from the target virtual character including the first virtual character; or enabling the target virtual character to obtain an attack rebound skill, the attack rebound skill being configured for: when the target virtual character is attacked by a virtual character or a non-player virtual character that is in a different camp from the target virtual character, rebounding the attack to the virtual character or the non-player virtual character that is in a different camp from the target virtual character, and the virtual character or the non-player virtual character that is in a different camp from the target virtual character including the first virtual character.

In one aspect, the enabling the target virtual character to obtain a target virtual skill includes: enabling the target virtual character to obtain the target virtual skill that is actively triggered; or enabling the target virtual character to obtain the target virtual skill that is passively triggered.

In one aspect, the method further includes: when the target virtual character is enabled to obtain the target virtual skill that is passively triggered, and a passive triggering condition of the target virtual skill is met, automatically triggering to cast the target virtual skill.

In one aspect, the in response to that the target speed falls within a target speed range, enabling the target virtual character to obtain a target virtual skill includes: when a distance between the target virtual character and the first virtual character is less than or equal to a preset distance threshold, in response to that the target speed falls within the target speed range, enabling the target virtual character to obtain the target virtual skill.

In one aspect, the method further includes: when a distance between the target virtual character and the first virtual character is less than or equal to a preset distance threshold, switching the state of the target virtual character to a melee attack state; and the in response to that the target virtual character is in a target state, adjusting a movement speed of the target virtual character to a target speed corresponding to the target state includes: in response to that the target virtual character is in the melee attack state, reducing the movement speed of the target virtual character to the target speed corresponding to the melee attack state.

According to another aspect described herein, a virtual character control apparatus is further provided, including: a display module, configured to display a target virtual character and a first virtual character in a virtual scene; a first response module, configured to: in response to that the target virtual character is in a target state, adjust a movement speed of the target virtual character to a target speed corresponding to the target state; and a second response module, configured to: in response to that the target speed falls within a target speed range, enable the target virtual character to obtain a target virtual skill, the target virtual skill being configured for defending against and/or attacking the first virtual character.

According to still another aspect described herein, a non-transitory computer-readable storage medium is further provided, the computer-readable storage medium storing a computer program, where the computer program is configured to perform the virtual character control method described above during running.

According to still another aspect described herein, a computer program product or a computer program is provided, the computer program product or the computer program including computer instructions, and the computer instructions being stored in a computer-readable storage medium. A processor of a computer device reads the computer instructions from the computer-readable storage medium, and the processor executes the computer instructions, so that the computer device performs the virtual character control method described above.

According to still another aspect described herein, an electronic device is further provided, including a memory and a processor, the memory storing a computer program, and the processor being configured to perform, through the computer program, the virtual character control method described above.

In aspects described herein, in response to that the target virtual character is in a target state, adjusting a movement speed of the target virtual character to a target speed corresponding to the target state; and in response to that the target speed falls within a target speed range, enabling the target virtual character to obtain the target virtual skill, the target virtual skill being configured for defending against and/or attacking the first virtual character. In this way, a player may change the state of the target virtual character and change the movement speed of the target virtual character through controlling, enabling the target virtual character to obtain the target virtual skill. In this way, a technical effect of increasing control on a virtual character in a game is achieved, and the technical problem that the control of the virtual character is monotonous is further resolved.

### BRIEF DESCRIPTION OF THE DRAWINGS

The accompanying drawings described herein are intended to provide further understanding of this application and constitute a part of this invention. Exemplary aspects described herein and the descriptions thereof are used for explaining this application rather than constituting the improper limitation to this application. In the accompanying drawings:

FIG. 1 is a schematic diagram of an application environment of an exemplary virtual character control method according to an aspect described herein.

FIG. 2 is a schematic flowchart of an exemplary virtual character control method according to an aspect described herein.

FIG. 3 is a schematic diagram of an exemplary virtual game scene according to an aspect described herein.

FIG. 4 is a schematic diagram of another exemplary virtual game scene according to an aspect described herein.

FIG. 5 is a schematic diagram of still another exemplary virtual game scene according to an aspect described herein.

FIG. 6 is a schematic diagram of still another exemplary virtual game scene according to an aspect described herein.

FIG. 7 is a schematic diagram of still another exemplary virtual game scene according to an aspect described herein.

FIG. 8 is a schematic diagram of still another exemplary virtual game scene according to an aspect described herein.

FIG. 9 is a schematic diagram of an overall process according to an aspect described herein.

FIG. 10 is a schematic diagram of a structure of an exemplary virtual character control apparatus according to an aspect described herein.

FIG. 11 is a structure block diagram of a computer system of an exemplary electronic device according to an aspect described herein.

FIG. 12 is a schematic diagram of a structure of an exemplary electronic device according to an aspect described herein.

### DETAILED DESCRIPTION

To make a person skilled in the art better understand solutions of this application, the following clearly and completely describes the technical solutions in the aspects described herein with reference to the accompanying drawings in the aspects described herein. Apparently, the described aspects are merely some rather than all of the aspects described herein. All other aspects obtained by a person of ordinary skill in the art based on the aspects described herein without creative efforts shall fall within the protection scope of this application.

In the specification, claims, and accompanying drawings of this application, terms such as “first” and “second” are used to distinguish between similar objects, but are not necessarily used to describe a specific order or sequence. Data used in such a way are interchanged in proper circumstances, so that the aspects described herein described herein can be implemented in other orders than the order illustrated or described herein. In addition, terms “include” and “have” and any of their variations are intended to cover nonexclusive including, for example, a process, method, system, product, or device that includes a series of steps or units do not have to be limited to those clearly listed steps or units, but may include another step or unit that is not clearly listed or is inherent to these process, method, product, or device.

For the terms “at least one”, “plurality”, “each”, and “any one” used in this application, the “at least one” includes one, two, or more, and the “plurality” includes two or more, the “each” refers to each of a corresponding plurality, and the “any one” refers to any one of a plurality. For example, a “plurality” of function controls includes three function controls, the “each” refers to each functional control of the three function controls, the “any one” refers to any one of the three function controls, which can be a first function control, or a second function control, or a third function control.

First, some nouns or terms that appear during description of the aspects described herein are applicable to the following explanations:

A shooting game includes, but is not limited to, a shooting game of a first-person perspective, a shooting game of a third-person perspective, and the like, and includes, but is not limited to, a game where firearms are used to perform a ranged attack.

A third-person perspective is a perspective that a virtual camera is at a position behind a virtual game character for a certain distance in a virtual game scene, and the virtual game character and all combat elements around in a virtual game environment may be seen in a screen.

Open world refers to a virtual game scene in a game is completely free and open, a player may freely move forward to explore in any direction, and distance between boundaries of various orientations is very large. In addition, the virtual game scene also includes virtual objects of various shapes and sizes, which can physically collide with or interact with entities such as a virtual character and a non-player virtual character.

A virtual character control method in this application may be applied to the virtual game scene in the open world described above. In the virtual game scene in the open world, the virtual character controlled by a player may be in the third-person perspective or may be in the first-person perspective.

Currently, in the virtual game scene of the open world, when the virtual game character controlled by the player moves, only a position of the virtual character in the virtual game scene is affected, while a skill of the virtual character is not affected. Usually, the player usually controls the virtual character to quickly move to a designated position, and then performs an operation such as an attack. Consequently, there is a problem of a monotonous control on the virtual character. It is difficult for the player to adjust loading of the virtual character based on a combat mode. As a result, a gameplay is simple, and game experience of the player is poor.

In this application, in a process of moving a target virtual character in a virtual game scene, a player may change a movement speed of the target virtual character by controlling a state of the target virtual character, so that the target virtual character is enabled to obtain a virtual skill corresponding to the movement speed (the virtual skill includes but is not limited to: boosting or reducing defense power of the virtual character, or boosting or reducing attack power of the virtual character). In this way, the player may be guided to control in real time, based on the combat mode in the virtual game scene, the virtual character to adjust the state, and change the movement speed, so that a system is enabled to automatically trigger a corresponding virtual skill based on a current state and/or the movement speed. The player does not need to continuously click/tap a virtual skill casting operation to trigger a corresponding virtual skill, thereby reducing a number of times of human-computer interaction, and saving system resources. In addition, a player may obtain maximum benefits from a combat. By adjusting a control behavior of the player, game complexity is improved, and game experience of the player is improved.

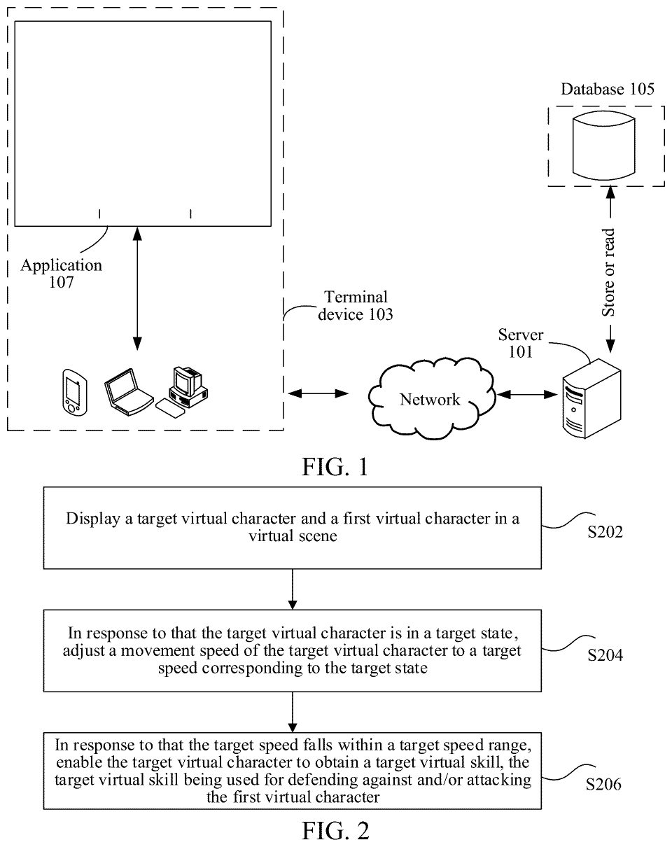

According to an aspect described herein, a virtual character control method is provided. In this embodiment, the virtual character control method may be applied to a hardware environment including a server 101 and a terminal device 103 shown in FIG. 1. As shown in FIG. 1, the server 101 is connected to the terminal device 103 through a network, and may be used to provide a service to the terminal device or an application installed on the terminal device. The application may be a video application, an instant messaging application, a browser application, a game application, or the like. A database 105 may be disposed on a server or independent from the server, and is configured to provide a data storage service to the server 101, for example, a game data storage server. The network may include, but is not limited to, a wired network and a wireless network, where the wired network includes a local area network, a metropolitan area network, and a wide area network, and the wireless network includes Bluetooth, WIFI, and other networks that implement wireless communication. The terminal device 103 may be a terminal configured with an application, and may include, but is not limited to, at least one of the following terminals: a computer device such as a mobile phone (e.g., an Android mobile phone, an iOS mobile phone, or the like), a notebook computer, a tablet computer, a palmtop computer, a mobile Internet device (MID), a portable android device (PAD), a desktop computer, or a smart television. The server may be a single server, or may be a server cluster formed by a plurality of servers, or may be a cloud server. An application 107 using the virtual character control method is displayed through the terminal device 103 or another connected display device.

With reference to FIG. 1, the virtual character control method may be performed on the terminal device 103 through the following operations:

S1: Display a target virtual character and a first virtual character in a virtual scene.

S2: In response to that the target virtual character is in a target state, adjust a movement speed of the target virtual character to a target speed corresponding to the target state.

S3: In response to that the target speed falls within a target speed range, enable the target virtual character to obtain a target virtual skill, the target virtual skill being configured for defending against and/or attacking the first virtual character.

In this aspect, the virtual character control method may alternatively be performed through a server, for example, performed through the server 101 shown in FIG. 1, or be jointly performed through a user terminal and a server.

The foregoing is only an example and is not specifically limited in this aspect.

In one aspect, as an exemplary implementation, as shown in FIG. 2, the virtual character control method includes:

Operation S202: Display a target virtual character and a first virtual character in a virtual scene.

Specifically, a virtual game scene may be displayed in a target game application. The target game application may be an application installed on the terminal device 103 shown in FIG. 1. The target game application includes, but is not limited to, a virtual shooting game, a racing game, a sports game, a puzzle game, an adventure game, a combat game, and the like. A player registers a game account on the target game application, and the player enters the virtual game scene by logging in to the registered game account in the target game application. The target virtual character may be a virtual game character controlled by the player in the virtual game scene. The first virtual character may be an enemy virtual character (belonging to a different camp from the target virtual character), or the first virtual character may be a non-player virtual character.

Operation S204: In response to that the target virtual character is in a target state, adjust a movement speed of the target virtual character to a target speed corresponding to the target state.

The movement speed of the target virtual character includes but is not limited to a default movement speed of the target virtual character, or may be a real-time movement speed of the target virtual character.

The default movement speed may be an initial movement speed preset for the target virtual character in the virtual game scene. In response to that the target virtual character is in the target state, the initial movement speed of the target virtual character is adjusted to a target movement speed corresponding to the target state.

The real-time movement speed of the target virtual character may be a movement speed of the target virtual character in various motion states. For example, a movement speed of the target virtual character when the target virtual character stays still is 0, and a movement speed of the target virtual character when the target virtual character runs at an accelerated speed is 100 m/s. In response to that the target virtual character is in the target state, the real-time movement speed of the target virtual character is adjusted to a movement speed corresponding to the target state.

The target state may be an action performed on the target virtual character, for example, rolling over, shoulder firing, iron sight, melee, jumping, and squatting. Alternatively, the target state may be a current state of the target virtual character, for example, the target virtual character enters a swamp area and changes to a motion limited state, or may be a melee attack state, or the like. The target state may also be a superposition of a plurality of states, for example, sprint acceleration, falling off from a higher spot, jumping in a sprint, and the like.

The target state may further be a state in which the target virtual character is attached or followed by a subordinate virtual character. The target virtual character may summon the subordinate virtual character, and attack the first virtual character or an enemy virtual character (i.e., a virtual character belonging to a different camp from the target virtual character) or a non-player virtual character in the virtual game scene by using the subordinate virtual character.

The subordinate virtual character has two forms. The subordinate virtual character in a first form is attached to the target virtual character (e.g., attached to an arm of the target virtual character), and the subordinate virtual character in a second form is independent from the target virtual character and may move along with the target virtual character.

The subordinate virtual character in the first form may be referred to as a first subordinate virtual character. The virtual scene further includes the first subordinate virtual character of the target virtual character. In response to an operation of summoning the first subordinate virtual character by the target virtual character, the first subordinate virtual character is attached to the target virtual character, and the state of the target virtual character is switched to an attached state; and in response to that the target virtual character is in the attached state, the movement speed of the target virtual character is reduced to a target speed corresponding to the attached state.

The subordinate virtual character in the second form may be referred to as a second subordinate virtual character. The virtual scene further includes the second subordinate virtual character of the target virtual character, and adjustment of the speed of the target virtual character may also enable the second subordinate virtual character to obtain a corresponding virtual skill. For example, in response to an operation of summoning the second subordinate virtual character by the target virtual character, the second subordinate virtual character is enabled to move along with the target virtual character; and in response to that the target speed falls within the target speed range, the second subordinate virtual character is enabled to obtain a first virtual skill (including but not limited to, boosting or reducing attack power of the second subordinate virtual character, and boosting or reducing defense power, an attacked recovery skill, an attack rebound skill, and the like of the second subordinate virtual character). The first virtual skill is configured for defending against or attacking the first virtual character, for example, attacking the first virtual character in response to that the target virtual character uses the first virtual skill of the second subordinate virtual character.

Operation S206: In response to that the target speed falls within a target speed range, enable the target virtual character to obtain a target virtual skill, the target virtual skill being configured for defending against and/or attacking the first virtual character.

Under a condition that a distance between the target virtual character and the first virtual character is less than or equal to a preset distance threshold, the in response to that the target speed falls within a target speed range, enabling the target virtual character to obtain a target virtual skill is triggered.

The movement speed of the target virtual character may be classified into a high-speed movement range and a low-speed movement range, the high-speed movement range corresponding to a preset first speed range, the low-speed movement range corresponding to a preset second speed range, and a speed in the second speed range is less than a speed in the first speed range. The target speed range may be a high-speed movement range, or may be a low-speed movement range.

For example, when the target speed is greater than a preset first movement speed threshold of the target virtual character, it is determined that the target speed falls within the first speed range; or when the target speed is less than a preset second movement speed threshold of the target virtual character, it is determined that the target speed falls within the second speed range.

The first movement speed threshold may be greater than or equal to the second movement speed threshold. For example, the first movement speed threshold and the second movement speed threshold may be default movement speeds of the target virtual character.

The default movement speed of the target virtual character is a preset movement speed, and may be an initial movement speed of the target virtual character when entering the game, or may be a movement speed when a movement operation is performed only on the target virtual character (i.e., a movement speed when no other operation similar to rolling over is performed or no skill is cast). A value of the default movement speed may be set according to an actual situation, for example, 5 m/s, 10 m/s, or the like. For example, the default movement speed of the target virtual character is 10 m/s. The first speed range (i.e., the high-speed movement range) may be a speed range greater than or equal to 10 m/s, and the second speed range (i.e., the low-speed movement range) may be a speed range less than 10 m/s.

In addition, in other implementations, the first movement speed threshold and the second movement speed threshold may alternatively be different preset movement speeds.

In response to that the target speed falls within the preset first speed range, the target virtual character is enabled to obtain an attack attribute boost skill and a defense attribute reduction skill, the target speed range including the first speed range, and the target virtual skill including the attack attribute promotion skill and the defense attribute reduction skill.

In response to that the target speed falls within the preset second speed range, the target virtual character is enabled to obtain an attack attribute reduction skill and a defense attribute boost skill, the target speed range including the second speed range, and the target virtual skill including the attack attribute reduction skill and the defense attribute boost skill.

Obtaining of the attack attribute boost skill indicates that an attack attribute of the target virtual character is boosted, and obtaining of the defense attribute reduction skill indicates that a defense attribute of the target virtual character is reduced. Obtaining of the attack attribute reduction skill indicates that an attack attribute of the target virtual character is reduced, and obtaining of the defense attribute boost skill indicates that a defense attribute of the target virtual character is boosted.

Adjustment values (i.e., boosted or reduced values) of the attack attribute and the defense attribute may be set according to an actual situation. The value of the attack attribute or the defense attribute of the target virtual character may be adjusted from a current value to a first target value in a manner corresponding to the target speed range, and the first target value may be set according to an actual situation.

In response to that the target speed falls within the first speed range, an attack attribute boost identifier and a defense attribute reduction identifier are displayed, the attack attribute boost identifier being configured for identifying that the target virtual character has obtained the attack attribute boost skill, and the defense attribute reduction identifier being configured for identifying that the target virtual character has obtained the defense attribute reduction skill.

In response to that the target speed falls within the second speed range, an attack attribute reduction identifier and a defense attribute boost identifier are displayed, the attack attribute reduction identifier being configured for identifying that the target virtual character has obtained the attack attribute reduction skill, and the defense attribute boost identifier being configured for identifying that the target virtual character has obtained the defense attribute boost skill.

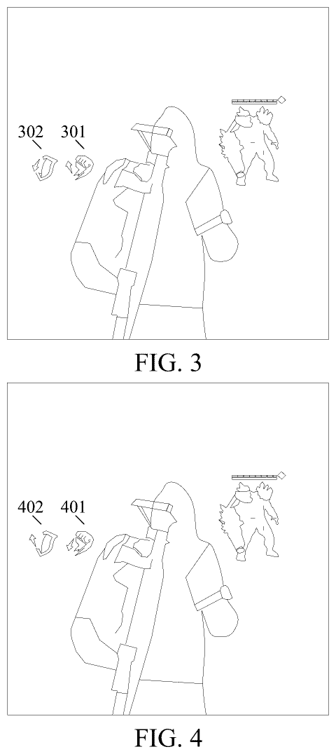

Game interfaces shown in FIG. 3 and FIG. 4 may be displayed in the target game application. The game interface shown in FIG. 3 displays an attack attribute boost identifier 301 and a defense attribute reduction identifier 302. The game interface shown in FIG. 4 displays an attack attribute reduction identifier 401 and a defense attribute boost identifier 402.

A motion state of the target virtual character may be classified into a high-speed motion state and a low-speed motion state. A movement speed corresponding to the high-speed motion state falls within the high-speed movement range, and a movement speed corresponding to the low-speed motion state falls within the low-speed movement range.

For example, as shown in the following Table 1, in response to that the target virtual character is in a state in a first group of motion states, it is determined that the movement speed of the target virtual character falls within the first speed range. In this case, the target speed range includes the first speed range, and the first group of motion states may include at least one of the following states: sprint acceleration, falling off from a higher spot, and jumping in a sprint.

Sprint acceleration, falling off from a higher spot, and jumping in a sprint in the first group of motion states are the high-speed motion states. When an operation in the first group of motion states, such as sprint acceleration, falling off from a higher spot, or jumping in a sprint, is performed, the movement speed of the target virtual character is a high movement speed. In this case, the movement speed of the target virtual character falls within the first speed range.

In response to that the target virtual character is in a second group of motion states, it is determined that the movement speed of the target virtual character falls within the second speed range. The target speed range includes the second speed range, and the second group of motion states may include at least one of the following states: rolling over, shoulder firing, iron sight, melee, jumping, and squatting.

As shown in Table 1, rolling over, shoulder firing, iron sight, melee, jumping, and squatting in the second group of motion states are the low-speed motion states. When an operation such as rolling over, shoulder firing, iron sight, melee, jumping, or squatting in the second group of motion states is performed, the movement speed of the target virtual character is a low movement speed. In this case, the movement speed of the target virtual character falls within the second speed range.

TABLE 1

| First group of motion states | Second group of motion states |
|---|---|
| Sprint acceleration | Rolling over |
| Falling off from a higher spot | Shoulder firing |
| Jumping in a sprint | Iron sight |
| | Melee |
| | Jumping |
| | Squatting |

As an exemplary implementation, the target virtual skill includes, but is not limited to, an attacked recovery skill, a hiding skill, an attack rebound skill, a support skill, and the like.

The attacked recovery skill is configured for increasing a health point of the target virtual character after the target virtual character is attacked. To be specific, the health point of the target virtual character may be increased after the target virtual character is attacked by the first virtual character, or the health point of the target virtual character may be increased after the target virtual character is attacked by another virtual character other than the first virtual character in the virtual game scene. An increased value of the health point may be a preset default value, for example, one point or two points of health. Alternatively, the increased value of the health point may be related to an attack received by the target virtual character. For example, if the target virtual character receives an attack by a shooting virtual prop, the increased value of the health point may be two points of health; and if the target virtual character receives an attack by a knife virtual prop, the increased value of the health point may be one point of health.

The hiding skill is configured for enabling a virtual character or a non-player virtual character that is in a different camp from the target virtual character not to find the target virtual character, the virtual character or the non-player virtual character in a different camp from the target virtual character including the first virtual character.

The attack rebound skill is configured for: when the target virtual character is attacked by a virtual character or a non-player virtual character that is in a different camp from the target virtual character, rebounding the attack to the virtual character or the non-player virtual character that is in a different camp from the target virtual character, the virtual character or the non-player virtual character that is in a different camp from the target virtual character including the first virtual character.

The support skill includes a first support skill and a second support skill.

Using an actual virtual game scene as an example, the target virtual character may summon a subordinate virtual character to support the target virtual character in performing an attack operation on the first virtual character. When the target virtual character meets a summoning condition, the subordinate virtual character in the virtual game scene may be summoned. The summoning condition includes but is not limited to that a virtual resource of the target virtual character reaches a preset resource threshold (which may be set according to an actual situation). The target virtual character may obtain the virtual resource by slaying a non-player virtual character in the virtual game scene or slaying a virtual character in a different camp from the target virtual character.

The subordinate virtual character summoned by the target virtual character has two states. One state is an attached state (i.e., a first subordinate virtual character), and another state is an independent following state (i.e., a second subordinate virtual character).

For the first support skill, the target virtual character summons the first subordinate virtual character to be attached to the target virtual character (which may be attached to a body of the target virtual character, for example, attached to an arm of the target virtual character). When the first subordinate virtual character is attached to the target virtual character, the movement speed of the target virtual character is reduced, to enable the target virtual character to obtain the target virtual skill. The target virtual character may attack the first virtual character by using the second virtual character.

For the second support skill, the second subordinate virtual character summoned by the target virtual character is independent, and the second subordinate virtual character may move along with the target virtual character. The movement speed of the target virtual character may enable the second subordinate virtual character to obtain a corresponding first virtual skill (including but not limited to an attack power boost skill, a defense power reduction skill, an attack power reduction skill, a defense power boost skill, and the like). When the target virtual character attacks the first virtual character, the first virtual character may be attacked by the second subordinate virtual character by using the first virtual skill.

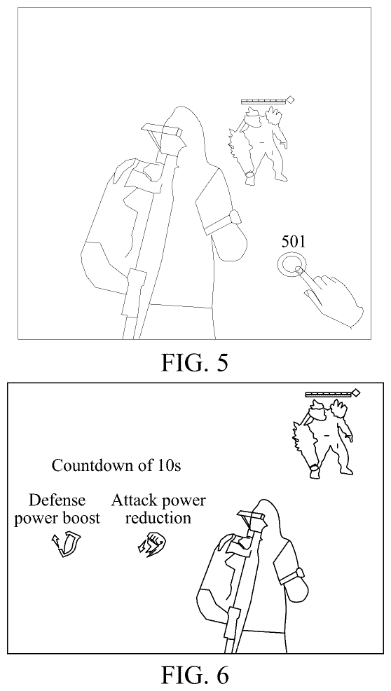

The target virtual skill may be an actively triggered skill or a passively triggered skill. For the actively triggered skill, a virtual button, such as a virtual button 501 shown in FIG. 5, of the target virtual skill is displayed on the game interface, and a player needs to tap/click the virtual button 501 to trigger the target virtual skill.

For the passively triggered skill, when the target virtual character is enabled to obtain the target virtual skill that is passively triggered, and a passive triggering condition of the target virtual skill is met, casting the target virtual skill is automatically triggered. The passive triggering condition includes but is not limited to that the target speed of the target virtual character falls within the target speed range, or a distance between the target virtual character and a non-player virtual character is less than a preset distance threshold, or a distance between the target virtual character and an enemy virtual character (i.e., a virtual character belonging to a different camp from the target virtual character) is less than a preset distance threshold (where the preset distance threshold may be set according to an actual situation).

A “waiting for inaction” effect may be introduced in a single round, the effect including a group of dynamic values. Different types of motion states correspond to different movement speeds, and the target virtual character is enabled to obtain a corresponding target virtual skill based on a movement speed corresponding to the type.

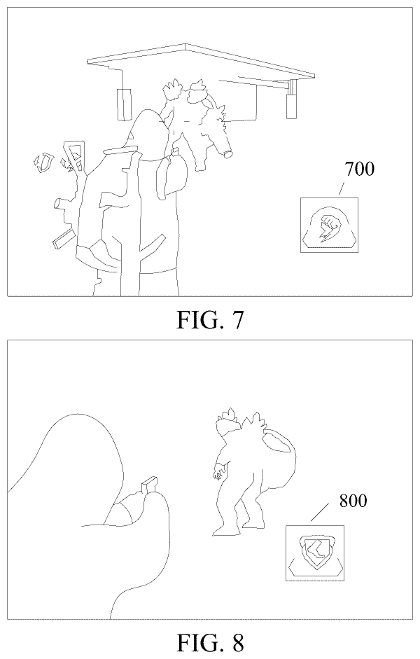

Countdown of the target virtual skill may further be displayed on the game interface of the target game application. As shown in FIG. 6, first countdown (i.e., 10 seconds shown in the figure, where duration of the first countdown may be set according to an actual situation) corresponding to the target virtual skill (i.e., the defense attribute boost skill and the attack attribute reduction skill) is displayed on a game interface. Before the first countdown ends, values of the attack attribute and the defense attribute of the target virtual character are adjusted first target values. When the first countdown ends, the values of the attack attribute and the defense attribute of the target virtual character is adjusted back to current values.

In response to that the target virtual character is switched from a target state to a first state, the movement speed of the target virtual character is adjusted to a first speed corresponding to the first state. In response to that the first speed falls within a first target speed range, the target virtual character is enabled to obtain a first target virtual skill, the first target virtual skill being configured for defending against or attacking the first virtual character.

Within the first countdown of the target virtual skill, in response to that the target virtual character is switched from a target state to a second state, the movement speed of the target virtual character is adjusted to a second speed corresponding to the second state; and in response to that the second speed falls within a second target speed range, the target virtual character is enabled to obtain a second target virtual skill, and the target virtual character has the second target virtual skill before the first countdown ends.

Referring to Table 2, this application is described below by using specific aspects.

TABLE 2

| Target state | Target virtual skill |
|---|---|
| Rolling over | Attacked recovery skill |
| Squatting | Hiding skill (i.e., not being found by an enemy virtual |
| | character or a non-player virtual character) |
| Melee | Attack rebound skill |

When the target state includes a rolling over state, and the target virtual character is in the rolling over state, the in response to that the target virtual character is in a target state, a movement speed of the target virtual character is adjusted to a target speed corresponding to the target state includes: in response to that the target virtual character is in the rolling over state, adjusting the movement speed of the target virtual character to a movement speed corresponding to the rolling over state. When the target virtual skill includes an attacked recovery skill, the in response to that the movement speed corresponding to the target state falls within a target speed range, enabling the target virtual character to obtain a target virtual skill includes: in response to that the movement speed corresponding to the rolling over state falls within the target speed range, enabling the target virtual character to obtain the attacked recovery skill. Further, in response to that the target virtual character uses the attacked recovery skill, a health point of the target virtual character is increased after the target virtual character is attacked by the first virtual character.

When the target state includes a squatting state, and the target virtual character is in the squatting state, the in response to that the target virtual character is in a target state, adjusting a movement speed of the target virtual character to a target speed corresponding to the target state includes: in response to that the target virtual character is in the squatting state, adjusting the movement speed of the target virtual character to a movement speed corresponding to the squatting state.

When the target virtual skill includes a hiding skill, the in response to that the movement speed corresponding to the target state falls within a target speed range, enabling the target virtual character to obtain a target virtual skill includes: in response to that the movement speed corresponding to the squatting state falls within the target speed range, enabling the target virtual character to obtain the hiding skill; and in response to that the target virtual character uses the hiding skill, enabling the first virtual character not to find the target virtual character.

For a melee state, when a distance between the target virtual character and the first virtual character is less than or equal to a preset distance threshold, the state of the target virtual character is switched to a melee attack state. In this case, the in response to that the target virtual character is in a target state, adjusting a movement speed of the target virtual character to a target speed corresponding to the target state includes: in response to that the target virtual character is in the melee attack state, reducing the movement speed of the target virtual character to the target speed corresponding to the melee attack state.

As an exemplary implementation, after the target virtual character has obtained the target virtual skill, a dynamic special effect may be displayed on the target virtual character. Different target virtual skills correspond to different dynamic special effects. For example, when the attack attribute of the target virtual character is boosted and the defense attribute of the target virtual character is reduced, a yellow dynamic special effect is displayed on the target virtual character. When the attack attribute of the target virtual character is reduced and the defense attribute of the target virtual character of the target virtual character is boosted, a blue dynamic special effect is displayed on the target virtual character.

As an exemplary implementation, when the virtual skill of the target virtual character in a target game application is adjusted in a manner corresponding to the first target speed range, an icon may further be displayed in the target game application. As shown in FIG. 7, a first icon 700 indicates that the attack power of the target virtual character is boosted and the defense power of the target virtual character is reduced. As shown in FIG. 8, a second icon 800 indicates that the defense power of the target virtual character is boosted and the attack power of the target virtual character is reduced.

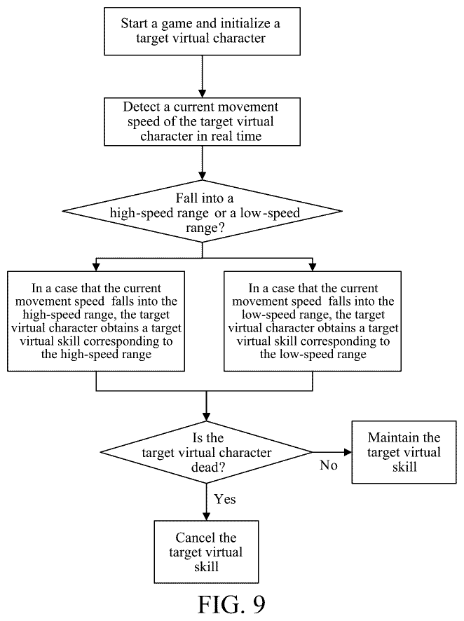

As an exemplary implementation, a flowchart of the overall framework shown in FIG. 9 includes the following operations:

Operation S901: Select a target virtual character from candidate virtual characters in a game lobby, initialize the target virtual character (e.g., initialize virtual equipment, clothes, props, and the like for the target virtual character), and enter a battle.

A player logs in to a game account to enter a target game application. In the target game application, the player starts the game by tapping a “start” button, and initializes the target virtual character after entering the game. Initialization includes but is not limited to initializing an outfit of the target virtual character and initializing a virtual prop used by the target virtual character.

In the game, the target virtual character may obtain a virtual resource (e.g., virtual gold coins) by slaying a non-player virtual character or an enemy virtual character, and the player may use the virtual resource to purchase different virtual props for the target virtual character to use.

A purchased virtual prop includes, but is not limited to, a shooting virtual prop, a summoning virtual prop, and the like. For example, a summoning virtual prop is purchased, the player controls the target virtual character to attack a non-player virtual character (or an enemy virtual character), and when a remaining health point of the non-player virtual character is less than a preset health point threshold (which may be set according to an actual situation, for example, health of 1 or 2 points), the non-player virtual character is summoned as a subordinate virtual character of the target virtual character in response to that the target virtual character uses the summoning virtual prop. The subordinate virtual character may have two forms. One is a form of being attached to the target virtual character, and the other is an independent form. The two forms of the subordinate virtual character may be switched by the player by using an instruction.

The subordinate virtual character in an attached form may be referred to as a first subordinate virtual character. Because the first subordinate virtual character is attached to a body of the target virtual character (e.g., attached to an arm of the target virtual character), a movement speed of the target virtual character is reduced (e.g., the movement speed of the target virtual character is reduced to a target movement speed), so that the target virtual character obtains a target virtual skill. The target virtual skill may be obtained for the target virtual character by using the first subordinate virtual character attached to the target virtual character.

The subordinate virtual character in an independent form may be referred to as a second subordinate virtual character, and the second secondary virtual character may move along with the target virtual character. The movement speed of the target virtual character changes with a motion state of the target virtual character, and the target virtual character may obtain the target virtual skill by changing the movement speed. In addition, the second subordinate virtual character may also obtain a virtual skill (e.g., a first virtual skill, including but not limited to an attack power boost skill, a defense power reduction skill, an attack power reduction skill, a defense power boost skill, and the like). By changing the movement speed, the second subordinate virtual character following the target virtual character is enabled to obtain a corresponding virtual skill.

Operation S902: Detect a current motion state of the target virtual character in real time, and obtain a current movement speed of the target virtual character.

The player may change the movement speed of the target virtual character by using a special virtual prop, or by using special terrain for the virtual character. For example, the player may increase the movement speed of the target virtual character in short time by using the virtual prop that accelerates the movement speed in short time. In this case, a server may detect that the movement speed of the target virtual character changes.

Operation S903: Retrieve, based on a pre-configured relationship, an adjustment manner of a virtual skill corresponding to a current movement speed of the target virtual character.

The pre-configured relationship includes, but is not limited to, a correspondence between a speed range and a virtual skill, and a correspondence between a motion state of the target virtual character and the target virtual skill (for example, the rolling over state corresponds to the attacked recovery skill) shown in Table 2.

The server enables the target virtual character to obtain the corresponding target virtual skill based on a speed range within which the current movement speed of the target virtual character falls. For example, the current motion state of the target virtual character is the rolling over state, a target virtual skill corresponding to a movement speed of the target virtual character in the rolling over state is the attacked recovery skill.

More virtual skill adjustment manners may be nested based on a movement speed level customized by the player, and a corresponding virtual skill adjustment manner may be performed by using a switch function.

Operation S904: If the movement speed of the target virtual character falls within a first speed range (a high-speed movement speed range), the target virtual character obtains a virtual skill corresponding to the high-speed movement range. When the target virtual character obtains the target virtual skill, an identifier corresponding to the target virtual skill is displayed on the target game application, and different identifiers are displayed based on different virtual skills.

Operation S905: During a game, a survival state of the target virtual character may be continuously detected, and when the target virtual character is alive, the target virtual character may obtain a corresponding virtual skill based on a real-time movement speed.

Operation S906: Cancel the target virtual skill of the target virtual character when the target virtual character in the virtual game scene is dead.

In this application, a player controls a target virtual character to be at different movement speeds, so that the target virtual character can obtain a corresponding virtual skill. Therefore, the player may purposely adjust and control the movement speed of the target virtual character with reference to a real-time virtual game scene, to maximize benefits from a combat.

In specific implementations described herein, relevant data such as user information is involved. When the foregoing aspects described herein are applied to specific products or technologies, permission or consent of a user needs to be obtained, and collection, use, and processing of the relevant data need to comply with relevant laws, regulations, and standards of relevant countries and regions.

For simple descriptions, the foregoing method aspects are stated as a series of action combinations. However, a person skilled in the art knows that this application is not limited to the sequence of the described actions because according to this application, some steps may use another sequence or may be simultaneously performed. In addition, a person skilled in the art is also to learn that the aspects described in this specification are all exemplary aspects, and the involved actions and modules are not necessarily required to this application.

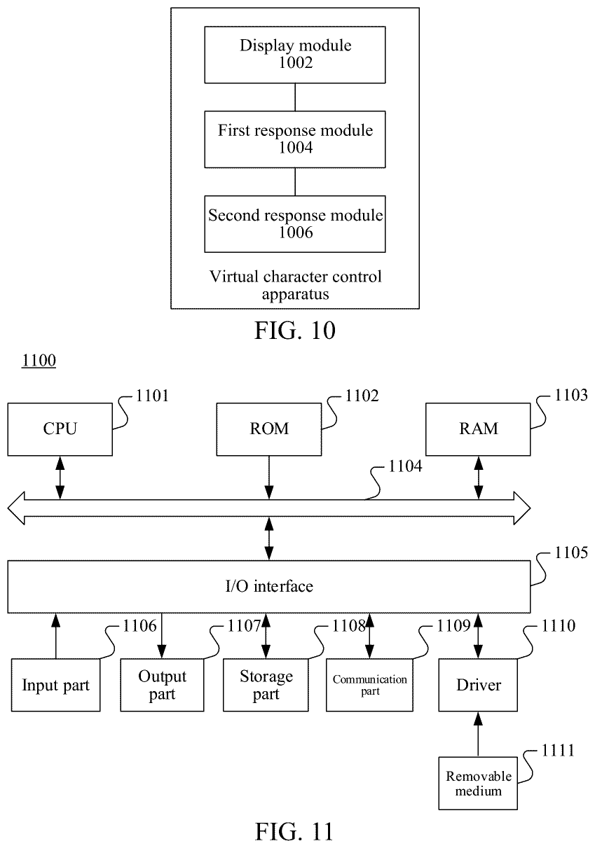

According to another aspect described herein, a virtual character control apparatus configured to perform the virtual character control method is further provided. As shown in FIG. 10, the apparatus includes: a display module 1002, configured to display a target virtual character and a first virtual character in a virtual scene; a first response module 1004, configured to: in response to that the target virtual character is in a target state, adjust a movement speed of the target virtual character to a target speed corresponding to the target state; and a second response module 1006, configured to: in response to that the target speed falls within a target speed range, enable the target virtual character to obtain a target virtual skill, the target virtual skill being configured for defending against and/or attacking the first virtual character.

In one aspect, the virtual scene further includes a first subordinate virtual character of the target virtual character, and the apparatus is further configured to: in response to an operation of summoning the first subordinate virtual character by the target virtual character, attach the first subordinate virtual character to the target virtual character, and switch the state of the target virtual character to an attached state. The in response to that the target virtual character is in a target state, adjusting a movement speed of the target virtual character to a target speed corresponding to the target state includes: in response to that the target virtual character is in the attached state, reducing the movement speed of the target virtual character to the target speed corresponding to the attached state.

In one aspect, the virtual scene further includes a second subordinate virtual character of the target virtual character, and the apparatus is further configured to: in response to an operation of summoning the second subordinate virtual character by the target virtual character, enable the second subordinate virtual character to move along with the target virtual character; and in response to that the target speed falls within the target speed range, enable the second subordinate virtual character to obtain a first virtual skill, the first virtual skill being configured for defending against or attacking the first virtual character.

In one aspect, the apparatus is further configured to: in response to that the target speed falls within a preset first speed range, enable the target virtual character to obtain an attack attribute boost skill and a defense attribute reduction skill, the target speed range including the first speed range, and the target virtual skill including the attack attribute boost skill and the defense attribute reduction skill; or in response to that the target speed falls within a preset second speed range, enable the target virtual character to obtain an attack attribute reduction skill and a defense attribute boost skill, the target speed range including the second speed range, and the target virtual skill including the attack attribute reduction skill and the defense attribute boost skill.

In one aspect, a speed in the second speed range is less than a speed in the first speed range.

In one aspect, the apparatus is further configured to: in response to that the target speed falls within the first speed range, display an attack attribute boost identifier and a defense attribute reduction identifier, the attack attribute boost identifier being configured for identifying that the target virtual character has obtained the attack attribute boost skill, and the defense attribute reduction identifier being configured for identifying that the target virtual character has obtained the defense attribute reduction skill; or in response to that the target speed falls within the second speed range, display an attack attribute reduction identifier and a defense attribute boost identifier, the attack attribute reduction identifier being configured for identifying that the target virtual character has obtained the attack attribute reduction skill, and the defense attribute boost identifier being configured for identifying that the target virtual character has obtained the defense attribute boost skill.

In one aspect, the apparatus is further configured to: when the target speed is greater than a preset first movement speed threshold of the target virtual character, determine that the target speed falls within the first speed range; or when the target speed is less than a preset second movement speed threshold of the target virtual character, determine that the target speed falls within the second speed range. The preset first movement speed threshold is less than or equal to the second movement speed threshold. In an implementation, the first movement speed threshold and the second movement speed threshold may be default movement speeds of the target virtual character.

In one aspect, the apparatus is further configured to: in response to that the target virtual character is in a state in a first group of motion states, determine that the movement speed of the target virtual character falls within the first speed range, the target speed range including the first speed range, and the first group of motion states including at least one of the following states: sprint acceleration, falling off from a higher spot, and jumping in a sprint; or in response to that the target virtual character is in a second group of motion states, determine that the movement speed of the target virtual character falls within the second speed range, the target speed range including the second speed range, and the second group of motion states including at least one of the following states: rolling over, shoulder firing, iron sight, melee, jumping, and squatting.

In one aspect, the apparatus is further configured to enable the target virtual character to obtain an attacked recovery skill, the attacked recovery skill being configured for increasing a health point of the target virtual character after the target virtual character is attacked; enable the target virtual character to obtain a hiding skill, the hiding skill being configured for enabling a virtual character or a non-player virtual character that is in a different camp from the target virtual character not to find the target virtual character, and the virtual character or the non-player virtual character in a different camp from the target virtual character including the first virtual character; and enable the target virtual character to obtain an attack rebound skill, the attack rebound skill being configured for: when the target virtual character is attacked by a virtual character or a non-player virtual character in a different camp from the target virtual character, rebound the attack to the virtual character or the non-player virtual character in a different camp from the target virtual character, and the virtual character or the non-player virtual character in a different camp from the target virtual character including the first virtual character.

In one aspect, the apparatus is further configured to enable the target virtual character to obtain the target virtual skill that is actively triggered; or enable the target virtual character to obtain the target virtual skill that is passively triggered.

In one aspect, the apparatus is further configured to: when the target virtual character is enabled to obtain the target virtual skill that is passively triggered, and a passive triggering condition of the target virtual skill is met, automatically trigger to cast the target virtual skill.

In one aspect, the apparatus is further configured to: when a distance between the target virtual character and the first virtual character is less than or equal to a preset distance threshold, in response to that the target speed falls within the target speed range, enable the target virtual character to obtain the target virtual skill.

In one aspect, the apparatus is further configured to switch the state of the target virtual character to a melee attack state when the distance between the target virtual character and the first virtual character is less than or equal to a preset distance threshold; and the in response to that the target virtual character is in a target state, adjusting a movement speed of the target virtual character a target speed corresponding to the target state includes: in response to that the target virtual character is in the melee attack state, reducing the movement speed of the target virtual character to the target speed corresponding to the melee attack state.

According to an aspect described herein, a computer program product is provided. The computer program product includes a computer program/instructions, the computer program/instructions including program codes configured for performing the methods shown in a flowchart. In such an aspect, the computer program may be downloaded and installed from a network through a communication part 1109, and/or installed from a removable medium 1111. When the computer program is executed by a central processing unit 1101, various functions provided in the aspects described herein are executed.

Sequence numbers of the aspects described herein are merely for description purpose but do not indicate the preference of the embodiments.

FIG. 11 schematically illustrates a structure block diagram of a computer system of an electronic device according to the aspects described herein.

A computer system 1100 of the electronic device shown in FIG. 11 is merely an example, and does not bring any limitation to the function and use scope of the aspects described herein.

As shown in FIG. 11, the computer system 1100 includes a central processing unit (CPU) 1101. The CPU 1101 may perform various appropriate actions and processing according to a program stored in a read-only memory (ROM) 1102 or a program loaded from a storage part 1108 into a random access memory (RAM) 1103. The RAM 1103 further stores various programs and data for operating the system. The CPU 1101, the ROM 1102, and the RAM 1103 are connected to each other through a bus 1104. An input/output (I/O) interface 1105 is also connected to the bus 1104.

The following components are connected to the input/output interface 1105: an input part 1106 including a keyboard, a mouse, and the like; an output part 1107 including a cathode ray tube (CRT), a liquid crystal display (LCD), a speaker, and the like; a storage part 1108 including a hard disk and the like; and a communication part 1109 including a network interface card such as a local area network card, a modem, and the like. The communication part 1109 performs communication processing by using a network such as the Internet. A driver 1110 is also connected to the I/O interface 1105. The removable medium 1111, such as a magnetic disk, an optical disc, a magneto-optical disk, or a semiconductor memory, is installed on the driver 1110, so that a computer program read from the removable medium is installed into the storage part 1108.

Particularly, according to the aspects described herein, the processes described in the method flowcharts may be implemented as computer software programs. For example, an aspect described herein includes a computer program product, the computer program product including a computer program carried on a computer-readable medium, and the computer program includes program code configured for performing methods shown in the flowcharts. In such an embodiment, the computer program may be downloaded and installed from a network through the communication part 1109, and/or installed from the removable medium 1111. When the computer program is executed by the CPU 1101, the various functions defined in the system described herein are executed.

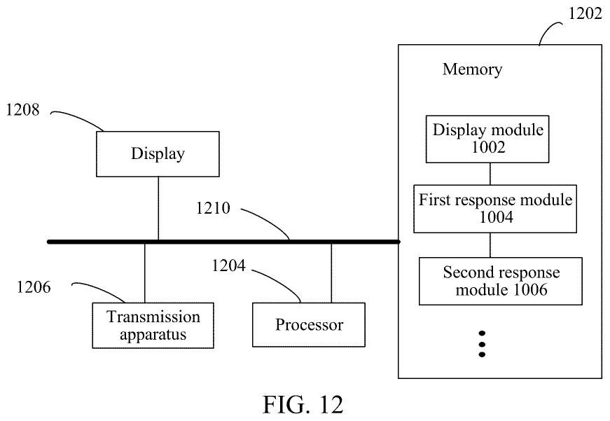

According to still another aspect described herein, an electronic device configured to perform the virtual character control method is further provided. The electronic device may be a terminal device or a server shown in FIG. 1. In this embodiment, an example in which the electronic device is a terminal device is used for description. As shown in FIG. 12, the electronic device includes a memory 1202 and a processor 1204. The memory 1202 stores a computer program. The processor 1204 is configured to perform the operations in any one of the method aspects through the computer program.

In this aspect, the electronic device may be located in at least one network device of a plurality of network devices in a computer network.

In this aspect, the processor may be configured to perform the following operations through the computer program:

S1: Display a target virtual character and a first virtual character in a virtual scene.

S2: In response to that the target virtual character is in a target state, adjust a movement speed of the target virtual character to a target speed corresponding to the target state.

S3: In response to that the target speed falls within a target speed range, enable the target virtual character to obtain a target virtual skill, the target virtual skill being configured for defending against and/or attacking the first virtual character.

In some aspects, a person of ordinary skill in the art may understand that the structure shown in FIG. 12 is merely an example. The electronic apparatus and the electronic device may alternatively be a terminal device such as a smartphone (such as an Android mobile phone or an iOS mobile phone), a tablet computer, a palmtop computer, a mobile internet device (MID), or a PAD. FIG. 12 does not limit the structure of the electronic apparatus and electronic device. For example, the electronic apparatus and the electronic device may further include more or fewer components (such as a network interface) than those shown in FIG. 12, or have a configuration different from that shown in FIG. 12.

The memory 1202 may be configured to store a software program and a module, for example, a program instruction/module corresponding to the virtual character control method and apparatus in the aspects described herein. The processor 1204 executes various functional applications and data processing by running the software program and module stored in the memory 1202, in other words, performs the virtual character control method. The memory 1202 may include a high-speed random access memory, and may further include a non-volatile memory such as one or more magnetic storage apparatuses, a flash memory, or another non-volatile solid-state memory. In some examples, the memory 1202 may further include memories remotely disposed relative to the processor 1204, and these remote memories may be connected to a terminal through a network. Examples of the network include but are not limited to an Internet, an intranet, a local area network, a mobile communication network, and a combination thereof. The memory 1202 may be specifically but is not limited to being used to store game data, including but not limited to information such as the target virtual character, the movement speed, and the virtual skill. As an example, as shown in FIG. 12, the memory 1202 may include but is not limited to the display module 1002, the first response module 1004, and the second response module 1006 of the virtual character control apparatus. In addition, the memory 1202 may further include, but is not limited to, another module unit in the virtual character control apparatus. Details are not described in this example again.

In one aspect, a transmission apparatus 1206 is configured to receive or send data through a network. A specific example of the network may include a wired network or a wireless network. In an example, the transmission apparatus 1206 includes a network interface controller (NIC). The NIC may be connected to another network device and a router by using a network cable, so that may communicate with the Internet or the local area network. In an example, the transmission apparatus 1206 is a radio frequency (RF) module, and is configured to wirelessly communicate with the Internet.

In addition, the electronic device further includes a display 1208, used to display the virtual game scene; and an interconnect bus 1210, used to connect various module components in the electronic device.

In other aspects, the terminal device or the server may be a node in a distributed system, where the distributed system may be a blockchain system. The blockchain system may be a distributed system formed by a plurality of nodes connected in the form of network communication. A peer to peer (P2P) network may be formed between the nodes. A computing device in any form, for example, an electronic device such as a server or a terminal, may become a node in the blockchain system by joining the P2P network.

According to an aspect described herein, a computer-readable storage medium is provided. A processor of a computer device reads the computer instruction from the computer-readable storage medium, and the processor executes the computer instruction, so that the computer device performs the virtual character control method provided in the foregoing various exemplary implementations.

In this aspect, the computer-readable storage medium may be configured to store a computer program for executing the following operations:

S1: Display a target virtual character and a first virtual character in a virtual scene.

S2: In response to that the target virtual character is in a target state, adjust a movement speed of the target virtual character to a target speed corresponding to the target state.

S3: In response to that the target speed falls within a target speed range, enable the target virtual character to obtain a target virtual skill, the target virtual skill being configured for defending against and/or attacking the first virtual character.

In this aspect, a person of ordinary skill in the art may understand that all or some of the steps of various methods in the foregoing aspects may be implemented by a program instructing relevant hardware of a terminal device. The program may be stored in a computer-readable storage medium. The storage medium may include: a flash drive, a read-only memory (ROM), a random access memory (RAM), a magnetic disk, an optical disc, or the like.

The sequence numbers of the aspects described herein are merely for description purpose but do not indicate the preference of the aspects.

If the integrated units in the foregoing aspects are implemented in a form of software functional units and are sold or used as an independent product, the units may be stored in the computer-readable storage medium. Based on such an understanding, the technical solutions described herein essentially, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of steps of the methods in the aspects described herein.

In the aspects described herein, descriptions of the aspects have different emphases, and as for parts that are not described in detail in one aspect, reference can be made to the relevant descriptions of the other aspects.

In the several aspects provided in the present application, a disclosed client end may be implemented in another manner. For example, the described apparatus aspects are merely exemplary. For example, the unit division is merely logical function division and may be other division during actual implementation. For example, a plurality of units or components may be combined or integrated into another system, or some features may be ignored or not performed. In addition, the coupling, or direct coupling, or communication connection between the displayed or discussed components may be the indirect coupling or communication connection by means of some interfaces, units, or modules, and may be electrical or of other forms.

The units described as separate parts may or may not be physically separate, and parts displayed as units may or may not be physical units, in other words, may be located at one position, or may be distributed on a plurality of network units. A part of or all of the units may be selected according to actual needs to achieve the objectives of the solutions of the aspects.

In addition, functional units in aspects described herein may be integrated into one processing unit, and each of the units may exist alone physically, or two or more units are integrated into one unit. The integrated unit may be implemented in a form of hardware, or may be implemented in a form of a software functional unit.

The foregoing descriptions are merely exemplary aspects described herein, and a person of ordinary skill in the art may make various improvements and modifications without departing from the spirit described herein. All such improvements and refinements shall fall within the protection scope of this application.

What is claimed is:

1. A virtual character control method, comprising:
displaying, within a virtual scene of a graphical user interface (GUI) on a user device, a target virtual character and a first virtual character;
in response to the target virtual character being in a target state, adjusting a movement speed of the target virtual character to a target speed corresponding to the target state;
in response to the target speed falling within a target speed range, enabling the target virtual character to obtain a target virtual skill, wherein the target virtual skill is configured for defending against or attacking the first virtual character; and
displaying, within the virtual scene, the adjusted target virtual character.

2. The method according to claim 1, wherein the virtual scene further comprises a first subordinate virtual character of the target virtual character, and wherein the method further comprises:
in response to an operation of summoning the first subordinate virtual character by the target virtual character:
attaching the first subordinate virtual character to the target virtual character; and
switching the target state, of the target virtual character, to an attached state; and
wherein the adjusting comprises: in response to the target state being the attached state, reducing the movement speed of the target virtual character.

3. The method according to claim 1, wherein the virtual scene further comprises a second subordinate virtual character of the target virtual character, and the method further comprises:
in response to an operation of summoning the second subordinate virtual character by the target virtual character, enabling the second subordinate virtual character to move along with the target virtual character; and
in response to the target speed falling within the target speed range, enabling the second subordinate virtual character to obtain a first virtual skill, wherein the first virtual skill is configured for defending against or attacking the first virtual character.

4. The method according to claim 1, wherein the in response to that the target speed falls within a target speed range, enabling the target virtual character to obtain a target virtual skill comprises:
in response to the target speed falling within a first speed range within the target speed range, enabling the target virtual character to obtain an attack attribute boost skill and a defense attribute reduction skill; or
in response to the target speed falling within a second speed range within the target speed range, enabling the target virtual character to obtain an attack attribute reduction skill and a defense attribute boost skill.

5. The method according to claim 4, wherein a speed within the second speed range is less than a speed within the first speed range.

6. The method according to claim 4, wherein the method further comprises:
in response to the target speed falling within the first speed range, displaying an attack attribute boost identifier and a defense attribute reduction identifier, wherein the attack attribute boost identifier is configured for identifying that the target virtual character has obtained the attack attribute boost skill, and the defense attribute reduction identifier is configured for identifying that the target virtual character has obtained the defense attribute reduction skill; or
in response to that the target speed falling within the second speed range, displaying an attack attribute reduction identifier and a defense attribute boost identifier, wherein the attack attribute reduction identifier is configured for identifying that the target virtual character has obtained the attack attribute reduction skill, and the defense attribute boost identifier is configured for identifying that the target virtual character has obtained the defense attribute boost skill.

7. The method according to claim 4, wherein the method further comprises:
determining, based on the target speed being greater than a first movement speed threshold, that the target speed falls within the first speed range; or
determining, based on the target speed being less than a second movement speed threshold, that the target speed falls within the second speed range,
wherein the second movement speed threshold is less than or equal to the first movement speed threshold.

8. The method according to claim 1, wherein the method further comprises:
in response to the target virtual character being in a state in a first group of motion states, determining that the movement speed of the target virtual character falls within a first speed range of the target speed range, and wherein the first group of motion states comprising at least one of the following states: sprint acceleration, falling off from a higher spot, or jumping in a sprint; or
in response to that the target virtual character being in a state in a second group of motion states, determining that the movement speed of the target virtual character falls within a second speed range of the target speed range, and wherein the second group of motion states comprising at least one of the following states: rolling over, shoulder firing, iron sight, melee, jumping, or squatting.

9. The method according to claim 1, wherein the target virtual skill comprises one of the following:
an attacked recovery skill configured for increasing a health point of the target virtual character after the target virtual character is attacked;
a hiding skill configured for enabling a virtual character or a non-player virtual character that is in a different camp from the target virtual character not to find the target virtual character, wherein the virtual character or the non-player virtual character in a different camp from the target virtual character comprising the first virtual character; or
an attack rebound skill configured for, when the target virtual character is attacked by a virtual character or a non-player virtual character that is in a different camp from the target virtual character, rebounding the attack to the virtual character or the non-player virtual character, wherein the virtual character or the non-player virtual character comprises the first virtual character.

10. The method according to claim 1, wherein the enabling the target virtual character to obtain a target virtual skill comprises:
enabling the target virtual character to obtain the target virtual skill that is actively triggered; or
enabling the target virtual character to obtain the target virtual skill that is passively triggered.

11. The method according to claim 10, wherein the method further comprises:
when the target virtual character is enabled to obtain the target virtual skill that is passively triggered and a passive triggering condition of the target virtual skill is met, automatically triggering to cast the target virtual skill.

12. The method according to claim 1, wherein the enabling the target virtual character to obtain the target virtual skill is further based on
a distance between the target virtual character and the first virtual character being less than or equal to a preset distance threshold.

13. The method according to claim 1, wherein
the method further comprises, based on a distance between the target virtual character and the first virtual character being less than or equal to a preset distance threshold, switching the target state of the target virtual character to a melee attack state; and
the adjusting comprises: in response to the target virtual character being in the melee attack state, reducing the movement speed of the target virtual character.

14. A virtual character control apparatus, comprising:
one or more processors;
memory storing instructions, when executed, configure the virtual character control apparatus to perform actions comprising:
displaying, within a virtual scene of a graphical user interface (GUI) on a user device, a target virtual character and a first virtual character;
in response to the target virtual character being in a target state, adjusting a movement speed of the target virtual character to a target speed corresponding to the target state;
in response to the target speed falling within a target speed range, enabling the target virtual character to obtain a target virtual skill, wherein the target virtual skill is configured for defending against or attacking the first virtual character; and
displaying, within the virtual scene, the adjusted target virtual character.

15. The virtual character control apparatus according to claim 14, wherein the virtual scene further comprises a first subordinate virtual character of the target virtual character, and wherein the instructions, when executed by the one or more processors, further configure the virtual character control apparatus to perform actions comprising:
in response to an operation of summoning the first subordinate virtual character by the target virtual character:
attaching the first subordinate virtual character to the target virtual character; and
switching the target state, of the target virtual character, to an attached state; and
wherein the instructions, when executed by the one or more processors, configure the virtual character control apparatus to adjust the movement speed by: in response to the target state being the attached state, reducing the movement speed of the target virtual character.

16. The virtual character control apparatus according to claim 14, wherein the virtual scene further comprises a second subordinate virtual character of the target virtual character, and wherein the instructions, when executed by the one or more processors, configure the virtual character control apparatus to perform actions comprising:
in response to an operation of summoning the second subordinate virtual character by the target virtual character, enabling the second subordinate virtual character to move along with the target virtual character; and
in response to the target speed falling within the target speed range, enabling the second subordinate virtual character to obtain a first virtual skill, wherein the first virtual skill is configured for defending against or attacking the first virtual character.

17. The virtual character control apparatus according to claim 14, wherein the instructions, when executed by the one or more processors, configure the virtual character control apparatus to enable the target virtual character to obtain the target virtual skill by:
in response to the target speed falling within a first speed range within the target speed range, enabling the target virtual character to obtain an attack attribute boost skill and a defense attribute reduction skill; or
in response to the target speed falling within a second speed range within the target speed range, enabling the target virtual character to obtain an attack attribute reduction skill and a defense attribute boost skill.

18. A non-transitory computer-readable medium storing instructions that, when executed, cause perform of actions comprising:
displaying, within a virtual scene of a graphical user interface (GUI) on a user device, a target virtual character and a first virtual character;
in response to the target virtual character being in a target state, adjusting a movement speed of the target virtual character to a target speed corresponding to the target state;
in response to the target speed falling within a target speed range, enabling the target virtual character to obtain a target virtual skill, wherein the target virtual skill is configured for defending against or attacking the first virtual character; and
displaying, within the virtual scene, the adjusted target virtual character.

19. The non-transitory computer-readable medium according to claim 18, wherein the virtual scene further comprises a first subordinate virtual character of the target virtual character, and wherein the instructions, when executed, further cause performance of actions comprising:
in response to an operation of summoning the first subordinate virtual character by the target virtual character:
attaching the first subordinate virtual character to the target virtual character; and
switching the target state, of the target virtual character, to an attached state; and
wherein the instructions, when executed, cause adjusting the movement speed by: in response to the target state being the attached state, reducing the movement speed of the target virtual character.

20. The non-transitory computer-readable medium according to claim 18, wherein the virtual scene further comprises a second subordinate virtual character of the target virtual character, and wherein the instructions, when executed, cause performance of actions comprising:
in response to an operation of summoning the second subordinate virtual character by the target virtual character, enabling the second subordinate virtual character to move along with the target virtual character; and
in response to the target speed falling within the target speed range, enabling the second subordinate virtual character to obtain a first virtual skill, wherein the first virtual skill is configured for defending against or attacking the first virtual character.
